(19) United States
(12) Patent Application Publication
(10) Pub. No.: US 2004/0126525 A1
(43) Pub. Date: Jul. 1, 2004

(54) Arrangement made of a plastic piece and a metallic insert

(76) Inventor: Werner Schnabel, Regensburg (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/735,955

(22) Filed: Dec. 15, 2003

Related U.S. Application Data
(63) Continuation of application No. PCT/EP03/50038, filed on Feb. 28, 2003.

(30) Foreign Application Priority Data
Apr. 23, 2002 (DE) 10218116.0

(51) Int. Cl. B32B 1/08

(52) U.S. Cl. 428/36.9

(57) ABSTRACT

An arrangement comprises a plastic piece and a metallic insert, of which the plastic piece comprises a fixing hole open at both ends for insertion of a securing screw to screw it to another part, and the metallic insert is designed as a cylindrical bush which can be inserted into the fixing hole of the plastic piece to limit the attachment forces applied to the plastic piece when it is screwed into place. The plastic piece comprises a projection on the hole wall of the fixing hole and the metallic insert comprises at least one recess on its outer wall which interacts with the projection when the metallic insert is inserted into the fixing hole, in order to hold the metallic insert in the fixing hole of the plastic piece.

### CROSS REFERENCE TO RELATED APPLICATION

This application is a continuation of copending International Application No. PCT/EP03/50038 filed Feb. 28, 2003 which designates the United States, and claims priority to German application DE102 18 116.0 filed Apr. 23, 2002.

### TECHNICAL FIELD OF THE INVENTION

The present invention relates to an arrangement made of a plastic piece and metallic insert for a fixing hole of the plastic piece as well as a plastic piece and a metallic insert for it.

### BACKGROUND OF THE INVENTION

Attaching plastic pieces, such as for example inlet manifolds for internal combustion engines, by means of screws is extremely problematical, since the attachment forces transferred by the fixing screws to the plastic piece (torque forces) can lead to deformation and flowing of the plastic. Metallic inserts (torque limiters) are therefore usually inserted into the fixing holes to limit the attachment forces transferred to the plastic piece.

Basically these metallic inserts can be divided up into two main types: With one main type the insert is longer than the fixing hole. The insert must then be securely fixed in the fixing hole. With the other main type the insert is shorter or only a little longer than the fixing hole. The insert is then supported to float in the fixing hole and must only be secured for transport. In this case the insert can be designed as a split pin which is held in the fixing hole by its inherent tension. Instead the insert can also be designed as a closed circular bush which is held in the fixing hole by being molded with the plastic of the plastic piece or having a corresponding hardness profile.

All these solutions are relatively expensive to manufacture and/or install. Also they do not always fulfill the conditions required for the specific purposes for which they are used.

### SUMMARY OF THE INVENTION

The underlying object of the present invention is to develop an arrangement of a plastic piece and a metallic insert of the specific generic model so as to make them cheap and easy both to manufacture and to assemble.

The object can be achieved by an arrangement comprising a plastic piece and a metallic insert, of which the plastic piece comprises a fixing hole open at both ends for insertion of a securing screw to screw it to another part, and the metallic insert is designed as a cylindrical bush which can be inserted into the fixing hole of the plastic piece to limit the attachment forces applied to the plastic piece when it is screwed into place, wherein the plastic piece comprises a projection on the hole wall of the fixing hole and the metallic insert comprises at least one recess on its outer wall which interacts with the projection when the metallic insert is inserted into the fixing hole, in order to hold the metallic insert in the fixing hole of the plastic piece.

The projection of the plastic piece can be a lug running in a circumferential direction. The projection of the plastic piece may have a triangular cross section. The projection of the plastic piece may extend over 360°. The projection of the plastic piece may lie in a radial level of the fixing hole which serves during manufacture of the plastic piece as a form separation level of a two-piece forming tool. The projection of the plastic piece may extend over less than 90°. The projection of the plastic piece can be provided at a flexible section of the hole wall of the plastic piece that serves during manufacture of the plastic piece for extracting a forming tool from the fixing hole. The flexible section can be formed by a void. The projection of the plastic piece can be arranged in the axial center of the fixing hole. The projection of the plastic piece can be offset sideways to the axial center of the fixing hole and is arranged with a gap between it and the axial ends of the fixing hole. The projection of the plastic piece can be arranged in one axial end of the fixing hole. The recess of the metallic insert may be a groove running in a circumferential direction with its shape matched to that of the projection. The recess can be arranged in the axial center of the metallic insert. The recess can be provided offset sideways to the axial center of the insert and a second recess is provided symmetrical to the axial center. The recess can be arranged at one or both ends of the metallic insert and consists of a chamfer in each case. The recess may consist of a reduced-diameter section of insert. The metallic insert may consist of a bush closed in the circumferential direction or axially split. The plastic piece can be an inlet manifold for an internal combustion engine.

The object can furthermore be achieved by a plastic piece for an arrangement with a plastic piece and a metallic insert, the plastic piece comprising a fixing hole open at both ends for insertion of a securing screw to screw it to another part, wherein the fixing hole is designed to receive the metallic insert to limit the attachment forces applied to the plastic piece when it is screwed into place, wherein the plastic piece further comprises a projection on the hole wall of the fixing hole for interacting with at least one recess on the outer wall of the metallic insert.

The object can also be achieved by a metallic insert for an arrangement including a plastic piece and the metallic insert, wherein the metallic insert is designed as a cylindrical bush which can be inserted into a fixing hole of the plastic piece to limit the attachment forces applied to the plastic piece and the metallic insert comprises at least one recess on its outer wall which interacts with a projection of the plastic piece when the metallic insert is inserted into the fixing hole, in order to hold the metallic insert in the fixing hole of the plastic piece.

According to this claim the plastic piece has a projection in the wall of the fixing hole concerned and the metallic insert has at least one recess on its circumference that interacts with the projection when the insert is pushed into the fixing hole, in order to hold the metallic insert in the fixing hole.

Both the projection of the plastic piece and the recess in the metallic insert can be produced during manufacturing of the plastic piece or metallic insert respectively without an additional manufacturing stage being required. The outstanding features of the solution in accordance with the invention are thus its ease of manufacturing and the correspondingly low manufacturing costs. Assembly is also particularly simple, since pushing the metallic insert into the fixing hole of the plastic piece automatically makes a connection between projection and recess, by which the metallic insert is held captively in the fixing hole.

In accordance with one embodiment of the invention there is provision for the projection of the plastic piece to be located in one radial level of the fixing hole that serves during production of the plastic piece as a form separation level of a forming tool divided up into two pieces. The projection, that is usefully designed as a lug running around the circumference, is then produced automatically during the deformation process. The outstanding feature of this solution is its particular simplicity.

In accordance with another embodiment of the invention there is provision for the projection of the plastic piece to be designed as a lug extending over less than 90° and at which a flexible section of the hole wall is provided. The flexible section is formed by an undercut and is used for extracting a forming tool from the fixing hole. This solution can be used whenever deformation to two sides is not possible during manufacturing of the plastic piece. Because of the flexible section of the hole wall there is spring-type engagement between projection and recess in this solution.

### BRIEF DESCRIPTION OF THE DRAWINGS

Exemplary embodiments of the invention are explained in more detail on the basis of the drawings. The drawings show:

FIG. 1 a side view of a metallic insert;

FIG. 2A cross-section of a part of a plastic piece with a fixing hole for the insert in FIG. 1;

FIG. 3 a view from above of the plastic piece in FIG. 2;

FIGS. 4 to 6, the views corresponding to those of FIGS. 1 to 3 of a derived embodiment of the invention;

FIGS. 7 to 9, the views corresponding to those of FIGS. 1 to 3 of a further embodiment of the invention;

FIGS. 10 to 12 the views corresponding to those of FIGS. 1 to 3 of a further embodiment of the invention.

### DETAILED DESCRIPTION OF THE PREFERRED EMBODIMENTS

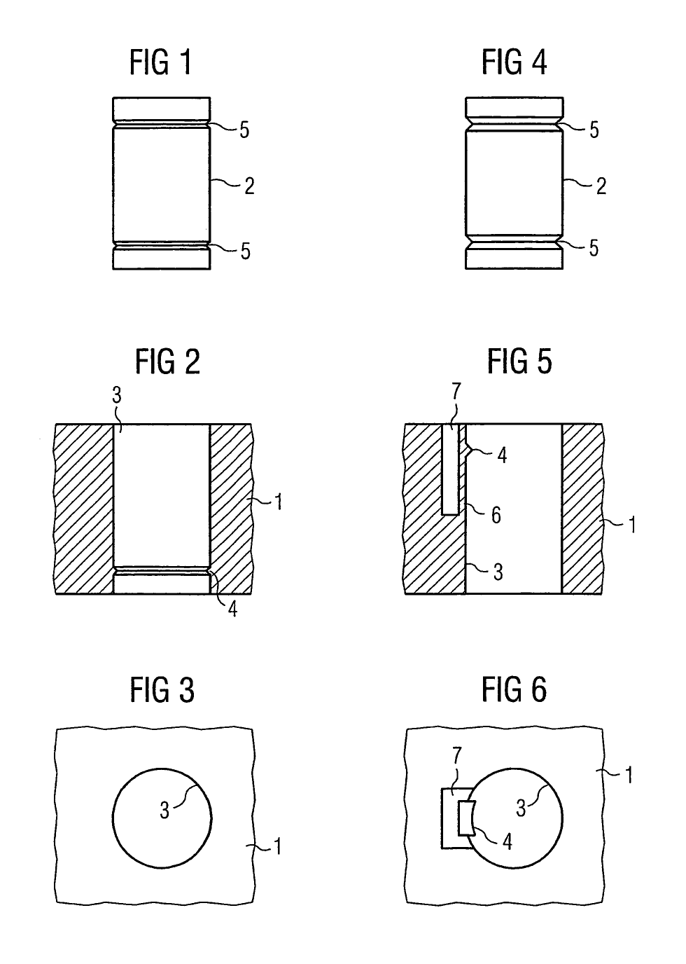

Looking first at FIGS. 1 to 3. FIG. 2 is a cross-section through an attachment flange of an (otherwise not shown) plastic piece 1 with a fixing hole 3. The fixing hole 3 is used for inserting a fixing screw (not shown) which is used to fix plastic piece 1 to another part. Plastic piece 1 might typically be the inlet manifold of an internal combustion engine that is naturally provided with a larger number of such fixing holes. Plastic piece 1 can however also be any other part that is to be attached by the corresponding fixing screws.

As shown in FIG. 2, the fixing hole 3 extends all the way through and is basically cylindrical in shape and is equipped with a projection 4 extending radially inwards. In the exemplary embodiment shown the projection 4 consists of tab extending for 360° around the inside circumference that is offset to the side of the axial center of fixing hole 3 and with a gap to the axial ends of the fixing hole 3. The projection 4 in the axial levels of the fixing hole 3 is triangular in cross section, preferably shaped like an equilateral triangle. The height of the projection 4 is typically 0.2 mm, and the gap between it and the bottom edge of attachment flange 3 of plastic piece 1 is typically around 2 mm.

It is useful for the circular projection 4 to be positioned at a radial level of fixing hole 3 that serves during the manufacture of plastic piece 1 as a form separation level for a forming tool which is a two-part design (not shown). Projection 4 is thus created automatically during the forming process. Because of the forming angle of the forming tool, projection 4 is then at the narrowest part of fixing hole 3, and its tolerances can be easily maintained. The forming tool is also simple to create.

FIG. 1 shows a metallic insert 2 which is pushed into fixing hole 3 of plastic piece 1 in order to limit the attachment forces transferred to plastic piece 1 during the processes used to attach it.

In the exemplary embodiment shown, insert 2 is designed as a cylindrical bush with an internal bore as shown and with two recesses 5 on its circumference. Each of the two recesses 5 is designed as a circular ring groove of which the shape is matched to the shape of projection 4. There is a gap between each of the recesses 5 and the associated axial end of the insert 2 which corresponds to the gap between projection 4 and the underside of the plastic piece 1. The external diameter of insert 2 essentially corresponds to the diameter of fixing hole 3, and the axial length of insert 2 essentially corresponds to the axial length of fixing hole 3.

If metallic insert 2 is thus pushed into fixing hole 3 of plastic piece 1, projection 4 locates into one of the two recesses 5. Insert 2 is then held securely in fixing hole 3 of plastic piece 1. A special insertion tool for pushing insert 2 into fixing hole 3 is not required here.

Insert 2 can, as shown, be designed as a solid circular bush, but it can also be a bush split longitudinally (split pin).

As shown and described, insert 2 is equipped with two recesses 5 arranged symmetrically to the axial center. It goes without saying however that just one recess 5 can also be provided. If in addition projection 4 is in the axial center of fixing hole 3 (which is not shown), insert 2 can then in any event be equipped with just one recess 5 which then also lies in the axial center of insert 2.

FIGS. 4 to 6 show a modified embodiment of the invention. The embodiment essentially differs from the embodiment shown in FIGS. 1 to 3 in that projection 4 does not extend around 360° of the circumference but by less than 90°, for example by around 45°, so that it is in the form of a lug. Projection 4 that for example has the same cross-sectional form as the previous exemplary embodiment, is provided at a flexible section 6 of the hole wall of fixing hole 3. The flexible section 6 is formed by a void 7. Void 7 consist of a cutout in the material of plastic piece 1 which separates all of flexible section 6 except for its lower end entirely from the rest of plastic piece 1. A type of hook is thus produced with projection 4 forming a sprung latching lug.

The embodiment of FIG. 5 is especially suitable for the case in which the forming tool used to manufacture plastic piece 1 cannot be deformed to both sides. Void 7 and flexible section 6 make it possible here to extract the forming tool from fixing hole 3.

Metallic insert 2 of FIG. 4 essentially corresponds to metallic insert 2 of FIG. 1. If insert 2 is pushed into fixing hole 3 of plastic piece 1, projection 4 locates in the associated recess 5 of insert 2. Because of the spring support, projection 4 and thus recess 5 can be designed to be larger than with the embodiment of FIGS. 1 to 3. This gives a particularly secure, close-fitting latched connection between projection 4 and recess 5.

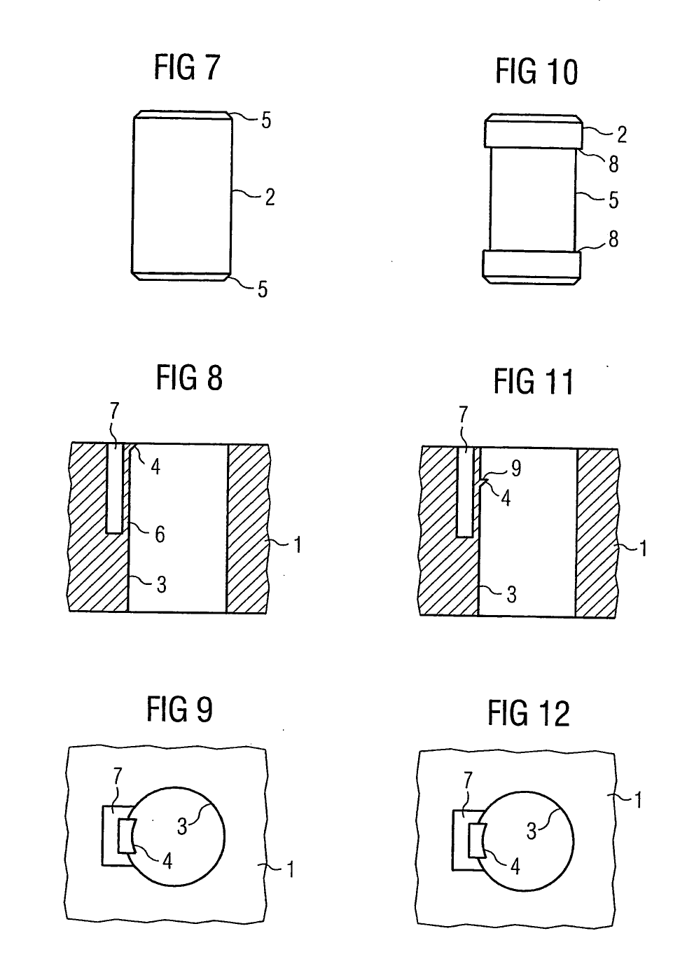

The embodiment of FIGS. 7 to 9 corresponds in its basic structure to the embodiment of FIGS. 4 to 6, but with provision for projection 4 as well as recesses 5 to be at one axial end of fixing hole 3 or at both axial ends of insert 2. Recesses 5 here are designed as simple chamfers. The shape projection 4, again in the form of a lug, corresponds here to the shape of the chamfers, i.e. projection 4 in FIG. 8 is to an extent half of projection 4 in FIG. 5.

The embodiment of FIGS. 10 to 12 again corresponds in its basic structure to the embodiment of FIGS. 4 to 6. With metallic insert 2 of FIG. 10 however, recess 5 is formed by a section of the insert with a reduced diameter, at the two ends of which a radial shoulder is provided in each case. Insert 2 is further provided with a chamfer at each of its two axial ends. Projection 4 in FIG. 11 is in this case designed as an acutely-angled lug with a radial upper face 9 and a rear face running at an acute angle.

Thus, if insert 2 is inserted from the underside of plastic piece 1 into fixing hole 3, the chamfer first slides over the rear face of projection 4 at one end of insert 2 until the upper face of projection 4 snaps into place behind the relevant shoulder 8. Metallic insert 2 is then securely located in fixing hole 3 of plastic piece 1.

We claim:

1. An arrangement comprising a plastic piece and a metallic insert, of which the plastic piece comprises a fixing hole open at both ends for insertion of a securing screw to screw it to another part, and the metallic insert is designed as a cylindrical bush which can be inserted into the fixing hole of the plastic piece to limit the attachment forces applied to the plastic piece when it is screwed into place, wherein the plastic piece comprises a projection on the hole wall of the fixing hole and the metallic insert comprises at least one recess on its outer wall which interacts with the projection when the metallic insert is inserted into the fixing hole, in order to hold the metallic insert in the fixing hole of the plastic piece.

2. The arrangement according to claim 1, wherein the projection of the plastic piece is a lug running in a circumferential direction.

3. The arrangement according to claim 1, wherein the projection of the plastic piece has a triangular cross section.

4. The arrangement according to claim 2, wherein the projection of the plastic piece extends over 360°.

5. The arrangement according to claim 2, wherein the projection of the plastic piece lies in a radial level of the fixing hole which serves during manufacture of the plastic piece as a form separation level of a two-piece forming tool.

6. The arrangement according to claim 2, wherein the projection of the plastic piece extends over less than 90°.

7. The arrangement according to claim 6, wherein the projection of the plastic piece is provided at a flexible section of the hole wall of the plastic piece that serves during manufacture of the plastic piece for extracting a forming tool from the fixing hole.

8. The arrangement according to claim 7, wherein the flexible section is formed by a void.

9. The arrangement according to claim 1, wherein the projection of the plastic piece is arranged in the axial center of the fixing hole.

10. The arrangement according to claim 1, wherein the projection of the plastic piece is offset sideways to the axial center of the fixing hole and is arranged with a gap between it and the axial ends of the fixing hole.

11. The arrangement according to claim 1, wherein the projection of the plastic piece is arranged in one axial end of the fixing hole.

12. The arrangement according to claim 1, wherein the recess of the metallic insert is a groove running in a circumferential direction with its shape matched to that of the projection.

13. The arrangement according to claim 9, wherein the recess is arranged in the axial center of the metallic insert.

14. The arrangement according to claim 10, wherein the recess is provided offset sideways to the axial center of the insert and a second recess is provided symmetrical to the axial center.

15. The arrangement according to claim 11, wherein the recess is arranged at one or both ends of the metallic insert and consists of a chamfer in each case.

16. The arrangement according to claim 1, wherein the recess consists of a reduced-diameter section of insert.

17. The arrangement according to claim 1, wherein the metallic insert consists of a bush closed in the circumferential direction or axially split.

18. The arrangement according to claim 1, wherein the plastic piece is an inlet manifold for an internal combustion engine.

19. A plastic piece for an arrangement with the plastic piece and a metallic insert, the plastic piece comprising a fixing hole open at both ends for insertion of a securing screw to screw it to another part, wherein the fixing hole is designed to receive the metallic insert to limit the attachment forces applied to the plastic piece when it is screwed into place, wherein the plastic piece further comprises a projection on the hole wall of the fixing hole for interacting with at least one recess on the outer wall of the metallic insert.

20. A metallic insert for an arrangement with a plastic piece and the metallic insert, wherein the metallic insert is designed as a cylindrical bush which can be inserted into a fixing hole of the plastic piece to limit the attachment forces applied to the plastic piece and the metallic insert comprises at least one recess on its outer wall which interacts with a projection of the plastic piece when the metallic insert is inserted into the fixing hole, in order to hold the metallic insert in the fixing hole of the plastic piece.
